(19) United States
(12) Patent Application Publication
(10) Pub. No.: US 2017/0166791 A1
(43) Pub. Date: Jun. 15, 2017

(54) COMPOSITION FOR ENHANCING TRACTION ON ICE AND SNOW

(71) Applicant: Steven Greenwald, Huntingdon Valley, PA (US)

(72) Inventor: Steven Greenwald, Huntingdon Valley, PA (US)

(21) Appl. No.: 14/966,391

(22) Filed: Dec. 11, 2015

(51) Int. Cl. C09K 3/14; C09D 1/10

(52) U.S. Cl. CPC C09K 3/149; C09D 1/10

(57) ABSTRACT

A composition of matter enhances friction of a surface covered with snow or ice. The composition includes particles of limestone and particles of volcanic rock, the particles having a size in a range of about 0.125-1.0 inches, and more preferably 0.125-0.25 inches. Limestone is present in the composition in a percentage of about 53-67%, by weight, and volcanic rock is present in a percentage of about 33-47%, by weight. The components are thoroughly mixed to form a homogeneous mixture. When the composition is applied to a snow-covered or ice-covered surface, the coefficient of friction of the surface increases so much that the surface can be considered a “non-slip” surface.

### BACKGROUND OF THE INVENTION

The present invention comprises a composition for improving traction on ice and/or snow.

Ice is slippery because of a free layer of water which rides on top of the ice sheet. This characteristic of ice is found throughout a wide range of temperatures.

Until relatively recently, it was widely believed that ice was slippery due largely to the fact that ice presents a hard and smooth surface, and that when foot or auto traffic attempts to traverse it, the traveling object cannot create sufficient friction to prevent slipping or sliding.

The solution used in the prior art, to increase the coefficient of friction of the surface, was to apply a quantity of grit, in the form of sand, cinders, or crushed stone. While this procedure will in fact increase traction or coefficient of friction, these substances need to bond to, or grip, the ice securely so that the object traveling on the ice, such as a shoe or tire, has an intermediate surface, such as sand, crushed rock, or cinders, which will not move, to allow the object to proceed normally. In practice, such solutions do not substantially increase the coefficient of friction, unless one saturates the area comprising the intermediate surface.

More recently, it became evident that it was the thin layer of water, which exists on the ice, which lubricates the surface. When an object attempts to move over the ice, it slips because the coefficient of friction is near zero. Thus, it is necessary to minimize or eliminate the layer of water.

The layer of water, on the surface of ice, exists throughout a wide range of temperatures. The use of absorbents, such as kitty litter or porous rock, reduces the amount of water to a limited extent, but the absorbents become overwhelmed with melt water, due to pressure or friction produced by the shoe or tire, and/or due to natural melting caused by the sun. The porous rock, used as an absorbent, would need to grip the ice by penetrating the surface of the ice, but it is too flat and too soft, and becomes crushed, and cannot penetrate sufficiently to prevent slipping to the extent needed to be classified as a non-slip surface.

To increase the coefficient of friction between ice and a vehicle or other object that travels across the surface of the ice, one needs 1) to eliminate the free water on the ice, and 2) to establish a non-slip, secure surface.

There have been attempts to decrease the amount of free water, on an ice sheet, using volcanic rock. The use of volcanic rock addresses only the first problem, namely that of excess water, but fails to establish a secure surface because the material is soft and easily crushed, and the particles are relatively flat or flake-like and cannot grip the ice.

Attempts have been made to create the secure surface, by introducing crushed stone, such as limestone. But this solution increases the coefficient of friction only slightly, because it fails to eliminate the cause of the slippery condition. The free water layer allows the stone to slide under pressure of the weight of the vehicle or other object. The stone therefore behaves like the blade of an ice skate.

The reason why the vehicle or other object glides so easily is that when it bites into the ice, it increases the amount of free water, upon which it glides, by what is known as pressure melting. The same action would occur with the limestone rock after one lays it down and travels upon it, as there is nothing to dissipate the free water.

The present invention solves the above-described problems, in a manner which overcomes the shortcomings of the prior art. The composition of the present invention both absorbs the water which sits on the sheet of ice, and penetrates the surface of the ice, to provide traction. Moreover, the composition is safe to handle, safe for the environment, and non-toxic.

The present invention provides a mixture of volcanic rock, having a particular range of particle size and shape, and crushed limestone, also having a particular range of particle size, using optimum proportions to maximize the coefficient of friction.

### SUMMARY OF THE INVENTION

The present invention comprises a composition for enhancing friction of a surface. The composition comprises particles of limestone and particles of volcanic rock, the preferred form of volcanic rock being one which has generally rounded particles, such as the material known as scoria. The particles of both the limestone and the volcanic rock have a size in the range of about 0.125-1.0 inches, and more preferably 0.125-0.25 inches. The limestone is present in the composition in a percentage, by weight, of about 53-67%, and the volcanic rock is present in a percentage, by weight, of about 33-47%. The particles of both limestone and volcanic rock are dried to a moisture content of about 1-2%. The particles of both components are combined to form a substantially homogeneous mixture.

The present invention also includes the method of using the composition described above. The composition is spread over a surface, such as a road or pavement which is at least partly covered by compacted snow and/or ice. The composition has been found substantially to increase the coefficient of friction of the surface, to a sufficient degree that the treated surface can be considered a “non-slip” surface, according to governmental regulations.

The invention therefore has the primary object of providing a composition for increasing traction on a surface covered by compacted snow and/or ice.

The invention has the further object of providing a composition as described above, wherein the composition is non-toxic and environmentally safe.

The invention has the further object of providing a composition as described above, wherein the composition is fast-acting, and wherein the composition is effective over a wide range of temperatures.

The invention has the further object of providing a composition as described above, wherein the composition is easy to apply, and wherein the composition effectively transforms a slippery, icy surface into a surface having the roughness of sandpaper.

The invention has the further object of providing a method of enhancing traction on a surface which is covered with snow and/or ice.

The invention has the further object of providing a method of making a composition for use in enhancing traction on a slippery surface.

The reader skilled in the art will recognize other objects and advantages of the present invention, from a reading of the following detailed description of the invention, and the appended claims.

### DETAILED DESCRIPTION OF THE INVENTION

The present invention comprises a composition of matter, the composition being useful in enhancing traction on ice or snow.

The composition of the present invention comprises a mixture of natural earth-based crystals, namely limestone and volcanic rock, which, when applied to the surface of ice, and in the correct proportions and particle sizes, will increase the coefficient of friction to such an extent that when an object comes in contact with the surface of the ice and pushes away, such as occurs with the normal movement of a shoe or a tire, the object will not slip under typical pressures, so that the object can continue to move along the surface.

The limestone used in the present invention can be obtained at building supply stores or from concrete block manufacturers. Examples include York Building Supplies, of York, Pa., and Duff Quarry, Inc., of Huntsville, Ohio. Limestone is nominally calcium carbonate. But the product which is commercially sold as limestone will, in general, have some impurities, which will vary according to the location of the mine from which the limestone is obtained.

The volcanic rock used in the composition of the present invention is preferably one which, when crushed, produces particles which are at least partly rounded. It has been found that rounded particles provide better mixing of the volcanic rock with the limestone. A preferred species of volcanic rock, used in the present invention, is the material known as scoria. The latter material has been found to have the desired concentration of vesicles, i.e. the desired porosity, and also yields rounded particles when crushed. The material can be obtained from quarries or landscaping outlets, or from a distributor, such as Colorado Lava, or Red Dome, Inc., of Fillmore, Utah.

The particle sizes of the components are very important to the efficacy of the mixture. As used herein, the term “size” means the longest dimension of a particle. It is crucial that the composition absorb the free water which is located on the surface of the ice. If the volcanic or lava rock particles are too large, the capillary action which needs to occur will be compromised. If the particles of volcanic rock are too small, there will be insufficient microscopic chambers in the rock, and the capillary action will not work.

The choice of limestone, as the component which provides traction, is related to the crystalline structure of the limestone. Limestone, when crushed, yields particles having spiky, angular protrusions. The pieces of limestone have a spiky shape, and are sufficiently durable to penetrate the ice surface without being further crushed. The formation of such spikes is an inherent consequence of the crushing of limestone.

In making the composition of the present invention, one must consider not only the proportions of the two components, but also the particle sizes of both. It is important that the composition be uniform, and that it not stratify or separate, and that it flow smoothly and not create a bumpy surface that in itself would be dangerous. In the present invention, the particle sizes for both components should be in the range of about ⅛ (or somewhat less, possibly as small as 1/16) to ¼ inches. It has been found that the surface of the ice is effectively penetrated by the limestone, while the volcanic rock absorbs the free water on the ice, thereby providing a stable, non-slip surface that has an enhanced coefficient of friction.

The desired range of size of particles of the volcanic rock is between about 0.125 and 1.0 inches, and, more preferably, between about 0.125 and 0.25 inches. Both components must be dried to contain about 1-2% water, and blended such that the limestone is present in a percentage, by weight, in the range of about 53-67%, and such that the volcanic rock is present in a percentage, by weight, in the range of about 33-47%.

That is, when the composition has 53% limestone, the percentage of volcanic rock in the composition will be 47%, and when the composition has 67% limestone, the percentage of volcanic rock will be 33%. In other words, the composition is substantially limestone and volcanic rock, so the percentages of these two components, in the composition, should sum to 100%.

The components are preferably dried in an oven, at about 500° F., until the moisture level reaches the desired value.

For the limestone, the particle size and shape are significant with regard to the ability of the limestone to provide traction. If the particles are too large, they form an uneven surface, which creates a safety issue for pedestrians. If the particles are too small, they will not bite sufficiently into the ice, and will provide little traction.

Also important in the composition of the present invention is that the components must blend together in a homogeneous mixture that is easily spread by use of available spreading devices. The relative particle sizes of the components must be considered to create both the homogeneity and the ability of the composition to be distributed.

It is important to understand the reasons for having a uniform product mixture with constant proportions of each component. First, the amount of traction produced depends critically on the availability of each component in each area to which it is applied. If these proportions are not constant, the maximum amount of traction that could be achieved will be compromised. Secondly, if the mixture is not uniform, it becomes more difficult to distribute or spread the product when it is applied to the surface.

In making the composition of the present invention, in which the proper particle sizes are essential, one passes both the limestone and volcanic rock through successive sieves, to achieve an optimum size of ⅛ (or slightly less) to ¼ inches.

The proportions of the components are important because there is a synergistic relationship between the components when the composition is in use. There must be a certain amount of water absorption, by the volcanic rock, so that the adjacent limestone will do its job of penetrating the ice.

It is preferred to use a ribbon mixer to combine the components, to insure that the mixture will be homogeneous.

The composition of the present invention is effective over a wide range of temperatures, and over a wide range of thicknesses of ice. It is also fast-acting. The composition is environmentally safe, non-toxic, and harmless to property and equipment. It meets the industrial standards set by the U.S. Occupational Safety and Health Administration (OSHA) to be classified as a non-slip surface. It is easy to apply, and effectively transforms a slippery, icy surface into a surface having the roughness of sandpaper.

It has been found that if the size of the limestone particles is larger than about 0.25 inches, no extra benefit is obtained, and the larger particles create a surface which is so uneven as to be unsafe. But if the particles are too small, they will not bite into the ice sufficiently to provide traction.

Similarly, it has been found that if the size of the volcanic rock particles is larger than about 0.25 inches, the capillary action that allows the material to absorb water will be compromised. On the other hand, if the volcanic rock particles are too small, they lose the microscopic chambers which produce the capillary action.

It is also necessary that the particles blend together in a homogeneous mixture that resists separation, and is easily spread with available spreading devices. The relative particle sizes and shapes affect the homogeneity of the mixture, and its ease of distribution. In particular, the reason for using scoria is that its shape is not as flat as other kinds of volcanic rock, but is somewhat more rounded.

The invention is not limited to the use of scoria. In general, it is preferred to use volcanic rock which, when crushed, produces particles which are at least somewhat rounded, because such particles blend more easily with the limestone particles.

It has been found that the degree of roundedness of the particles does not affect the efficacy of the volcanic rock for use in absorbing water, but only affects the ease with which the particles of volcanic rock can be mixed with particles of limestone.

Compositions made according to the present invention were tested using a swing pendulum, on which there was mounted a material (rubber or leather) which would simulate tires or shoes. The tests were conducted during periods of an hour. The compositions of the present invention were found to result in a dynamic coefficient of friction (DCOF) of 0.57. As defined by OSHA, a surface having a coefficient of friction above 0.54 is considered to be a non-slip surface.

The following are examples of compositions made according to the present invention.

### EXAMPLE 1

Limestone and volcanic rock were crushed, and then passed through a screen or sieve, to yield particles having sizes of about 3/16 inches, or slightly less. Then the limestone was dried in an oven at 500° F., until its water content was about 1%. A quantity of crushed limestone and a quantity of crushed volcanic rock (scoria) were selected, such that the limestone was 60% by weight, and the volcanic rock was 40%, by weight, of the overall composition. The components were thoroughly mixed together, to form a homogeneous mixture.

### EXAMPLE 2

The process of Example 1 was repeated, except that the proportions of the components were 55% limestone, and 45% volcanic rock, by weight.

The reader skilled in the art will recognize that the invention may be modified. As noted above, the invention is not limited to a particular form of volcanic rock, and other species could be used. Such modifications should be considered to be within the spirit and scope of the following claims.

What is claimed is:

1. A composition for enhancing friction of a surface, the composition comprising particles of limestone and particles of volcanic rock, the particles having a size in a range of about 0.125 to 1.0 inches, and wherein the composition includes limestone in a percentage of about 53-67%, by weight, and wherein the composition includes volcanic rock in a percentage of about 33-47%, by weight.

2. The composition of claim 1, wherein the size of the particles is in a range of about 0.125 to 0.25 inches.

3. The composition of claim 2, wherein the particles of limestone have spikes capable of protruding into ice or snow.

4. The composition of claim 2, wherein the particles of volcanic rock are at least somewhat rounded.

5. The composition of claim 2, wherein at least one of the limestone particles and the particles of volcanic rock is dried to a moisture content of about 1-2%.

6. The composition of claim 1, wherein the volcanic rock comprises scoria.

7. The composition of claim 2, wherein the volcanic rock comprises scoria.

8. A method of enhancing friction of a surface, the method comprising the steps of:
a) combining particles of limestone and particles of volcanic rock into a mixture, wherein the particles of limestone and volcanic rock have a size in a range of about 0.125-1.00 inches, wherein the limestone is present in the mixture in a percentage of about 53-67% by weight, wherein the volcanic rock is present in the mixture in a percentage of about 33-47%, by weight, and wherein the mixture comprises a homogeneous mixture of the particles of limestone and volcanic rock, and
b) applying the mixture to a surface to enhance friction of the surface.

9. The method of claim 8, wherein step (a) comprises selecting the size of the particles to be in a range of about 0.125-0.25 inches.

10. The method of claim 9, wherein step (a) comprises selecting the volcanic rock to be scoria.

11. The method of claim 9, wherein step (a) comprises selecting the volcanic rock such that the particles of volcanic rock are at least somewhat rounded.

12. The method of claim 8, wherein step (a) includes the step of drying the particles to a moisture content of about 1-2%.

13. A method of making a composition for enhancing friction of a surface, the method comprising the steps of:
a) providing a quantity of particles of limestone and particles of volcanic rock, the particles being chosen to have a size in a range of about 0.125-1.0 inches,
b) drying said particles of limestone and particles of volcanic rock to a moisture content of about 1-2%,
c) combining said particles of limestone and particles of volcanic rock, in proportions such that the limestone is present, in a final mixture, in a percentage of about 53-67%, by weight, and wherein volcanic rock is present, in a final mixture, in a percentage of about 33-47%, by weight, and
d) mixing said particles of limestone with said particles of volcanic rock, to produce a substantially homogeneous mixture.

14. The method of claim 13, further comprising selecting a size of the particles of limestone, and the particles of volcanic rock, to have a size in a range of about 0.125-0.25 inches.

15. The method of claim 14, further comprising selecting the volcanic rock to be scoria.

16. The method of claim 14, further comprising selecting the volcanic rock such that the particles of volcanic rock are at least partially rounded.
